(19) United States
(12) Patent Application Publication
(10) Pub. No.: US 2006/0012116 A1
(43) Pub. Date: Jan. 19, 2006

(54) Method of playing multiple games with a lottery ticket

(76) Inventor: John G. Lovell SR., Knoxville, TN (US)

Correspondence Address: PITTS AND BRITTIAN P C, P O BOX 51295, KNOXVILLE, TN, 37950-1295, US

(21) Appl. No.: 10/891,365

(22) Filed: Jul. 14, 2004

(51) Int. Cl. A63F 3/06; G06F 17/00

(52) U.S. Cl. 273/138.1; 273/139; 463/17

(57) ABSTRACT

A multiple game lottery-type game card that encourages increased consumer traffic at the retail point of distribution. The multiple game lottery-type game card member includes at least first and second indicia areas. A standard lottery-type game is played in the first indicia area. The second indicia area includes a unique identification symbol that is utilized for playing a second lottery-type game. An area of weakness is disposed on the card member such that the second indicia area can be separated from the game card. The second lottery-type game is played after all of the cards in a given series are sold and the winning unique identification symbol is revealed at the point of sale. This serves to encourage increased consumer traffic at the point of sale as players return to the point of sale to determine whether they have won the second lottery-type game.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of Invention

This invention pertains to lotteries. More particularly, this invention pertains to instant lotteries in which each ticket includes a stub carrying indicia for a secondary lottery whereby the secondary lottery game increases consumer traffic for a ticket vendor.

2. Description of the Related Art

The sale of lottery tickets can provide a substantial source of revenue for the outlets selling the tickets. More importantly, the sale of lottery tickets draws buyers into business establishments, such as gas stations and convenience stores, where they frequently purchase additional items, over and above the lottery tickets. These additional sales can also provide substantial sources of revenue for the vendor. Accordingly, it is desirable to create an additional incentive for a purchaser of a lottery ticket to return to the vendor's place of business after purchasing a lottery ticket. U.S. Pat. No. 5,472,196 issued Dec. 5, 1995 to Kenneth R. Rusnak discloses game pieces in which promotional tickets purchased, or given away, at a first location encourage patrons of the first location to visit a second location in order to play a second game. Various lottery tickets and lottery games are known in the art. For instance, U.S. Pat. No. 5,628,684 issued on May 13, 1997, to Jean-Etienne Bouedec discloses a game ticket for playing a second game in which a winning ticket is utilized to play the second game on a game console which is under the control of a remote computer at a central site. U.S. Pat. No. 5,772,511 issued on Jun. 30, 1998, to Walter M. Smeltzer discloses a method for conducting lotteries which combines instant games with online games. U.S. Pat. No. 6,447,395 issued on Sep. 10, 2002, to Mark Stevens discloses a game ticket for use with live-action keno-type games. U.S. Pat. No. 6,497,408 issued on Dec. 24, 2002, to Jay S. Walker, et al discloses a method of playing lottery games in which participants in a primary lottery drawing may elect to participate in a second, derivative, lottery drawing which gives players a chance to win the second game if the player loses, or fails to win above a threshold level, in the primary lottery drawing. U.S. Pat. No. 6,663,105 issued on Dec. 16, 2003, to Scott L. Sullivan, et al discloses a promotional game or lottery in which the awards are access to one or more predetermined internet-based services or sites and in which rewards and benefits are thereafter available to the player at retail stores and internet sites. And, U.S. Pat. No. 5,685,541 issued on Nov. 11, 1997, to John G. Lovell, Sr., the inventor of the present invention, discloses a multiple field game card for playing a lottery game in the style of BINGO.

What is missing from the art is a multiple play lottery-type game that provides both an incentive for repeat play and an incentive for winning players to return to selected vendors, thereby increasing the vendor's consumer traffic.

### BRIEF SUMMARY OF THE INVENTION

According to one embodiment of the present invention, a multiple game lottery-type game card is provided. The game card of the present invention includes at least two indicia areas. The first indicia area is provided with a plurality of concealed game fields that include symbols, either alphanumeric, iconographic or a combination of each for playing a lottery-type game. A player reveals one or more of the game fields, in accordance with the rules of the lottery-type game, to determine if the game card is a winning card. The second indicia area includes a unique identification symbol that can be a serial number, bar code or other digital identification symbol, or a combination of these. This unique identification symbol is used to play a second lottery-type game. The winning unique identification symbol is revealed after all of the game cards of a given series, or deal, have been sold. In one embodiment, the player having the winning game card for the second lottery type game must present the winning game card in order to win the second lottery type game. By utilizing a two-part card that allows a player the opportunity to qualify for a second lottery-type game, the winner of which is revealed at a later date, consumer traffic is increased for the retail outlet selling the multiple game lottery-type tickets.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 is a plan view of one embodiment for a multiple game lottery ticket in accordance with the present invention.

FIG. 2 is a plan view of an alternate embodiment of a multiple game lottery ticket.

FIGS. 3 and 4 are a flow chart depicting the method of playing multiple lottery type games in accordance with the present invention.

### DETAILED DESCRIPTION OF THE INVENTION

A game card, such as a lottery ticket, for playing multiple games constructed in accordance with the present invention is designated generally as 10 in the Figures. Game card 10 is preferably a planar card member constructed of card stock as is commonly used for lottery type tickets. However, those skilled in the art will recognize that other geometric configurations and materials can be utilized.

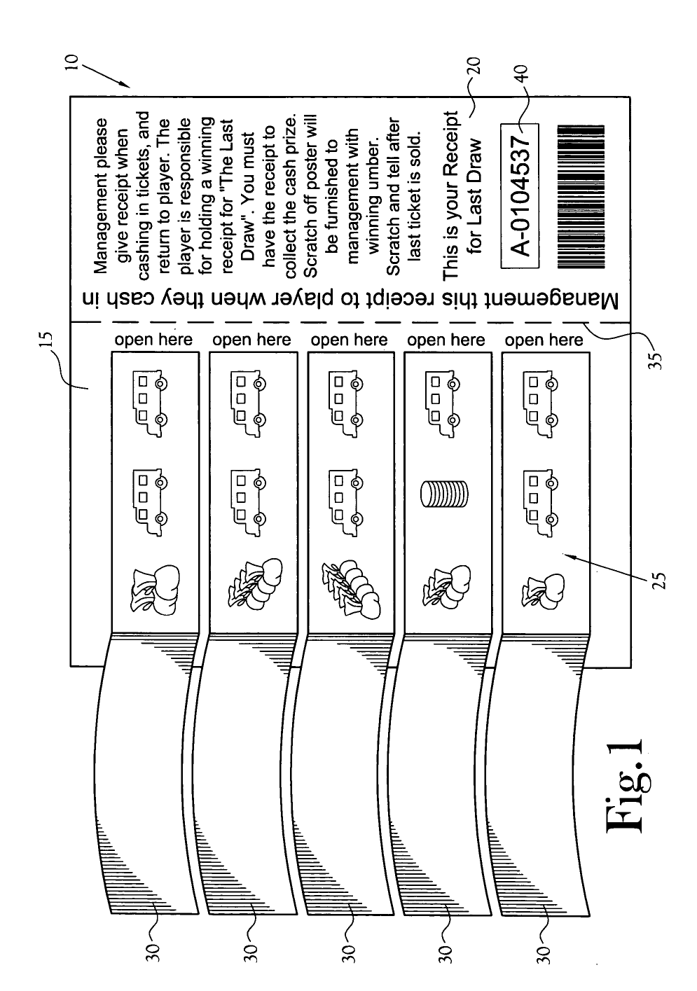

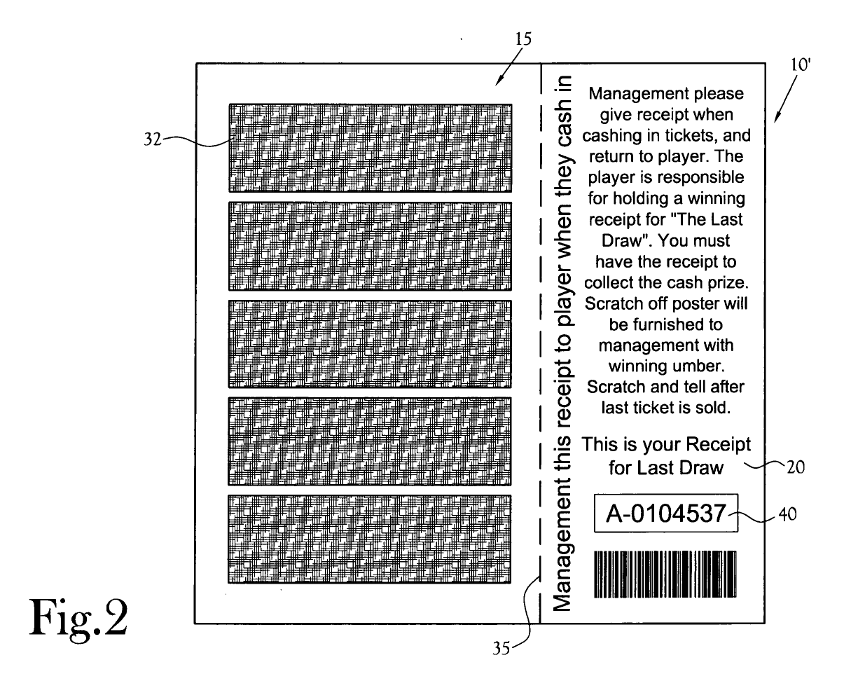

Game card 10 includes a first indicia area 15 and a second indicia area 20. First indicia area 15 preferably includes a plurality of concealed playing fields 25, each of which includes a combination of symbols, either alphanumeric, iconographic or a combination of the two, for playing a first game of chance, such as a lottery or other promotional type game. A winning combination of symbols can be predetermined as will be readily recognized by those skilled in the art. It will also be appreciated by those skilled in the art that the symbols can be concealed by a pull tab 30 as illustrated in FIG. 1. Alternatively with game card 10′, as illustrated in FIG. 2, the symbols can be concealed by a covering 32 defined by an opaque coating that is readily removable by scratching. An area of weakness 35 is disposed, preferably, between the first indicia area 15 and the second indicia area 20 in order to allow the separation of the second indicia area 20 from the game card 10 such that the removed portion of the card containing the second indicia area 20 defines a ticket stub. In the absence of an area of weakness, indicia can be provided for identifying the portion of the game card 10 to be cut, or torn, from game card 10.

The second indicia area 20 can include indicia such as trademarks or instructions for playing the game, but primarily includes a unique identification symbol 40, such as a serial number, which can be displayed in either alphanumeric format, barcode or other digital format or a combination of these. The unique identification symbol 40 is utilized for playing a second game of chance. Thus, the purchasing player is provided with the opportunity to play multiple games of chance with the purchase of a single lottery ticket.

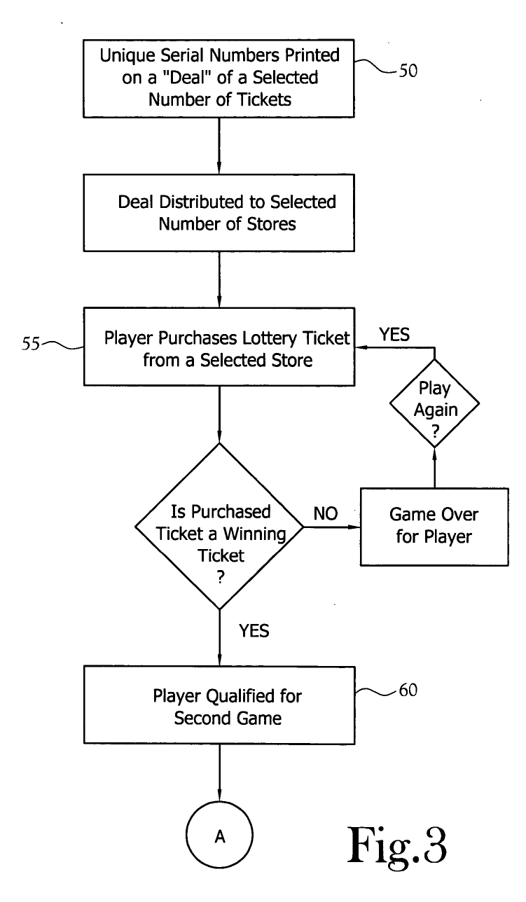

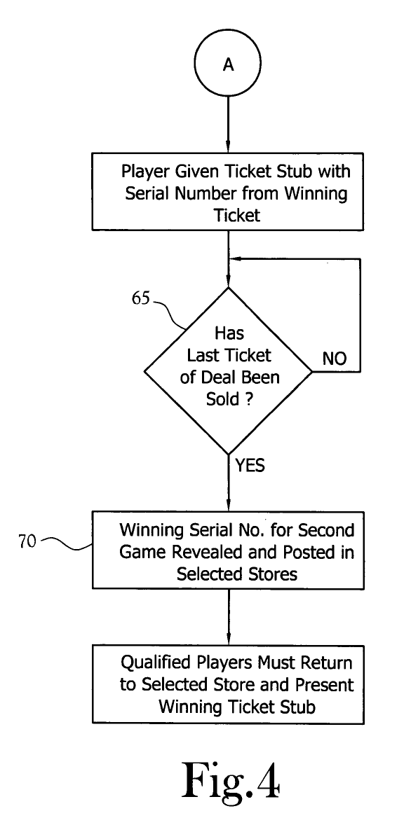

Referring to FIGS. 3 and 4, one method of conducting multiple lottery-type games of chance utilizing game card 10 will be discussed. In accordance with the present invention, a series of unique identification symbols are generated and are printed on a selected number of game cards 10, or tickets, at 50 in FIG. 5, such that each of the selected number of game cards 10 includes a unique identification symbol, preferably in the second indicia area 20. This selected number of game cards 10 is referred to herein as a “deal”. The deal is then distributed to a selected number of distribution sites, such as various retail outlets. As discussed above, each of the game cards 10 include a plurality of concealed playing fields 25. When a player purchases, or is given, a game card 10, at 55 in FIG. 5, the player reveals one of the concealed playing fields 25 in order to play the first lottery-type game.

As will be understood by those skilled in the art, the odds of winning the first lottery type game are determined in advance. In other words, when a deal of game cards is generated, the operator, or purveyor, of the lottery-type game determines both the type of lottery game and the odds of a given game card 10 including a winning combination of symbols. In this regard, at the discretion of the game's purveyor, winning combinations of symbols can be printed on game cards 10 such that only one in four cards, or one in three cards or other ratios of cards, will include a winning combination of symbols. Upon purchase of a game card 10 a player would reveal each of the concealed playing fields in order to determine whether the game card 10 is a winning card. While the game card 10 could include only one concealed playing field 25, a plurality of concealed playing fields 25 to be revealed keeps the player engaged in the game and also creates opportunities for various formats of lottery-type games. For instance concealed playing fields in the form of playing cards could be used to play a poker-type lottery game; the concealed playing fields could mimic the appearance of a slot machine. Those skilled in the art will recognize that there are numerous ways to play the first lottery type game. Alternately, every game card 10 could contain at least one winning combination of symbols, and a player possessing such a game card must reveal the winning combination of symbols in order to win the first lottery-type game. In other words, the game card 10 illustrated in FIG. 1, includes five concealed playing fields 25. Assuming that game card 10 includes a winning combination of symbols, the players odds of winning, i.e. revealing the correct playing field are one in five, it being understood that revealing multiple concealed playing fields will, in one embodiment, void the game card 10. Of course, in an alternate method of play, the value of a winning game card 10 would be reduced with each successive concealed playing field 25 that must be revealed in order to reveal the winning combination of symbols.

At the time that a player reveals a concealed playing field 25, a determination is made as to whether the game card 10 is a winning card. This determination is, as is common in the art, often made at the point of sale. If the game card is not a winning card, the game is over and the player can choose whether or not to play again. On the other hand, if the game card 10 is a winning game card, the player is qualified for the second lottery-type game, at 60 in FIG. 5. In this event, the unique identification symbol 40 is entered into a database from which the winning unique identification symbol 40 will be selected. While the unique identification symbol 40 can be either an alphanumeric character, a barcode or other digital representation, use of a bar code or digital representation, either alone or in combination with the alphanumeric representation of the unique identification symbol 40, facilitates entry of the unique identification symbol 40 into an electronic database without the need for typing the unique identification symbol 40 into the database The player is then given a ticket stub from the winning game card 10 that includes the second indicia area containing the unique identification symbol 40.

When it has been determined, by any acceptable means of tracking inventory, that all of the tickets/game cards from the deal have been sold or otherwise distributed, at 65 in FIG. 6, the winning unique identification symbol is revealed and posted in the selected retail outlets where the deal was originally distributed, 70 in FIG. 6. In one embodiment of the multiple lottery-type game, the qualified player possessing the ticket stub with the winning unique identification symbol must return to one of the selected retail outlets and present the winning ticket stub in order to win the second lottery-type game.

It will be recognized that this second lottery-type game creates an incentive for qualified players to make multiple return trips to the retail outlet where the lottery-type game was purchased in order to determine if the winning number has been revealed and to present the winning ticket. This increases customer traffic for the retail outlets distributing the multiple game lottery tickets of the present invention.

From the foregoing description, it will be recognized by those skilled in the art that a multiple game lottery-type ticket, and a method for utilizing the same, which will increase customer traffic for stores distributing the multiple game lottery ticket has been provided. While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

Having thus described the aforementioned invention, we claim:

1. A game card for playing multiple games, said game card comprising:
a card member having at least first and second indicia areas;
said first indicia area having at least one concealed playing field, each of said at least one playing fields including a combination of symbols for playing a first game of chance, whereby a player can selectively reveal a concealed playing field; and
said second indicia area having a unique identification symbol disposed thereon, wherein said unique identification symbol is utilized for playing a second game of chance, whereby a purchaser of said game card is provided with the opportunity to play multiple games of chance.

2. The game card of claim 1 wherein said card member is printed on card stock.

3. The game card of claim 1 wherein each of said at least one concealed playing field are concealed by a covering defined by a coating that is readily removeable by scratching.

4. The game card of claim 1 wherein said each of said at least one concealed playing fields is concealed by a removable pull tab.

5. The game card of claim 1 wherein said game card further comprises an area of weakness disposed on said card member such that said second indicia area can be separated from said game card.

6. A game card for playing multiple games, said game card comprising:
a card member having at least first and second indicia areas;
said first indicia area having a plurality of concealed playing fields, each of said playing fields including a combination of symbols for playing a first game of chance, whereby a player can selectively reveal a concealed playing field;
said second indicia area having a unique identification symbol, wherein said unique identification symbol is utilized for playing a second game of chance, whereby a purchaser of said game card is provided with the opportunity to play multiple games of chance; and
an area of weakness disposed on said card member such that said second indicia area can be separated from said game card whereby said second indicia area defines a ticket stub to be given to the purchaser for playing a second game of chance.

7. A method of conducting a lottery utilizing multiple game lottery tickets, said method comprising the steps:
generating a series of unique identifiers;
printing each of a selected number of tickets with a unique identifier from said series of unique identifiers, wherein said selected number of tickets defines a deal, wherein each of said tickets are defined by
a card member having at least first and second indicia areas;
an area of weakness disposed between said first and said second indicia areas whereby said second indicia area can be separated from said game card;
said first indicia area having a plurality of concealed playing fields, each of said playing fields including a combination of symbols for playing a first game of chance, whereby a player can selectively reveal a concealed playing field;
said second indicia area including said unique identifier;
distributing said deal to selected vendors whereby players can purchase tickets and play a first lottery by revealing a selected concealed playing field in said first indicia area and can also qualify to play a second lottery utilizing said unique identifier.
